(19) United States
(12) Patent Application Publication
(10) Pub. No.: US 2018/0042421 A1
(43) Pub. Date: Feb. 15, 2018

(54) Christmas tree lights hanger

(71) Applicant: Albert Bennett, Fort McMurray (CA)

(72) Inventor: Albert Bennett, Fort McMurray (CA)

(21) Appl. No.: 15/469,535

(22) Filed: Mar. 26, 2017

(30) Foreign Application Priority Data
Aug. 9, 2016 (GB) 1615303.3

(51) Int. Cl. A47G 33/10; F21V 21/00; A47G 33/08; F21S 4/10

(52) U.S. Cl. CPC A47G 33/10; F21S 4/10; F21V 21/00; A47G 33/0863; F21W 2121/04

(57) ABSTRACT

A Christmas tree lights hanger is provided, comprising a frustum cone member having a top portion, a bottom portion, and a hollow interior, wherein the hollow interior is configured to be placed on a leader branch of a Christmas tree; a hub member extending perpendicularly from the bottom portion; a plurality of spokes extending radially from the hub member, wherein each of the plurality of spokes has a distal end and a proximal end, wherein each of the plurality of spokes has a plurality of teeth that define a plurality of gaps, wherein the combination of teeth and gaps provide a plurality of hooks, the plurality of hooks are located on the left and right side of each of the plurality of spokes providing support for hanging strings of Christmas lights; and a curved catch located at the distal end of each of the plurality of spokes, wherein the curved catch is configured to prevent the strings of lights from falling off a spoke of the plurality of the spokes.

### CROSS-REFERENCE TO RELATED APPLICATIONS

The present application claims priority to United Kingdom Patent Application serial number 1615303.3, filed on Sep. 8, 2016 entitled “Christmas tree lights hanger”, the disclosure of which is hereby incorporated in its entirety at least by reference.

### BACKGROUND OF THE INVENTION

### 1. Field of the Invention

The present invention generally relates to decorating accessories, but more particularly to a Christmas tree lights hanger.

### 2. Description of Related Art

It is well known in the art that decorating a Christmas tree is a very time consuming process, especially if a picturesque Christmas tree is desired. When decorating a natural Christmas tree, the tree limbs become weak over time and begin to sag under the weight of the decorations, especially the lights. Therefore, the nice trimming that was originally done prior to the decoration becomes undone and does not look nice. Consequently, there is a need for a Christmas tree lights hanger that will support the tree lights and keep the Christmas tree and trimming in good condition.

### BRIEF SUMMARY OF THE INVENTION

In one embodiment of the present invention a tree lights hanger is provided, comprising: a frustum cone member having a top portion, a bottom portion, and a hollow interior, wherein the hollow interior is configured to be placed on a leader branch of a tree; a hub member extending perpendicularly from the bottom portion; and a plurality of spokes extending radially from the hub member, wherein each of the plurality of spokes has a distal end and a proximal end.

In one embodiment, each of the plurality of spokes has a plurality of teeth that define a plurality of gaps, wherein the combination of teeth and gaps provide a plurality of hooks. In one embodiment, the plurality of hooks are located on the left and right side of each of the plurality of spokes providing support for hanging strings of lights. In another embodiment, each of the plurality of spokes comprises a curved catch at the distal end. In yet another embodiment, the curved catch is configured to prevent the strings of lights from falling off a spoke of the plurality of the spokes.

In one embodiment, the top portion of the frustum cone member is configured to hold a tree-topper decoration. In another embodiment, the tree lights hanger is made from an integral piece of injection molded polymer based resin. In one embodiment, the tree is a Christmas tree.

In another aspect of the invention a Christmas tree lights hanger is provided comprising: a frustum cone member having a top portion, a bottom portion, and a hollow interior, wherein the hollow interior is configured to be placed on a leader branch of a Christmas tree; a hub member extending perpendicularly from the bottom portion; a plurality of spokes extending radially from the hub member, wherein each of the plurality of spokes has a distal end and a proximal end, wherein each of the plurality of spokes has a plurality of teeth that define a plurality of gaps, wherein the combination of teeth and gaps provide a plurality of hooks, the plurality of hooks are located on the left and right side of each of the plurality of spokes providing support for hanging strings of Christmas lights; and a curved catch located at the distal end of each of the plurality of spokes, wherein the curved catch is configured to prevent the strings of lights from falling off a spoke of the plurality of the spokes.

In one embodiment, wherein the top portion of the frustum cone member is configured to hold a Christmas tree-topper decoration. In another embodiment, the Christmas tree lights hanger is made from an integral piece of injection molded polymer based resin.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view a Christmas tree lights hanger according to an embodiment of the present invention.

FIG. 2A is a top perspective view of a Christmas tree lights hanger according to an embodiment of the present invention.

FIG. 2B is a side perspective view of a Christmas tree lights hanger according to an embodiment of the present invention.

FIG. 3 is a perspective view a Christmas tree lights hanger in use according to an embodiment of the present invention.

FIG. 4 is a cross-sectional view taken along section line 4-4 of FIG. 3.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a Christmas tree lights hanger.

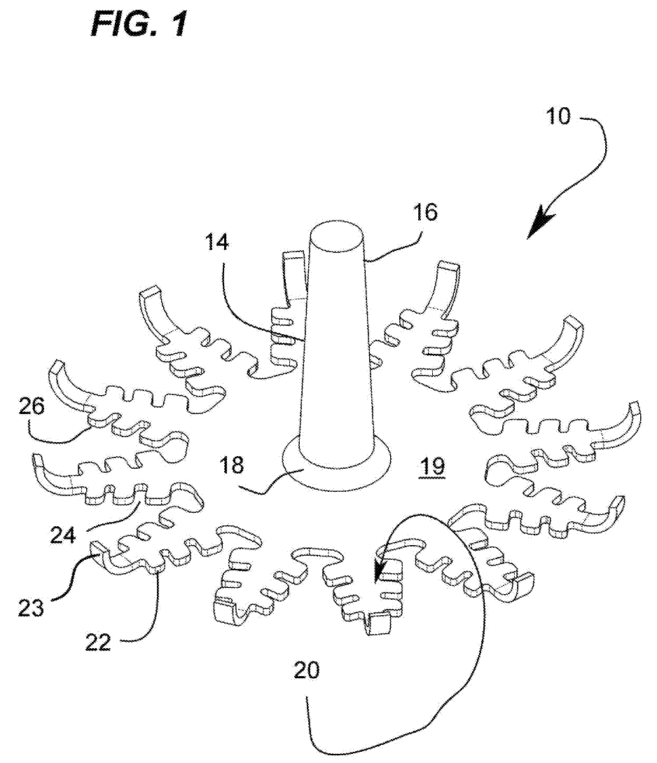

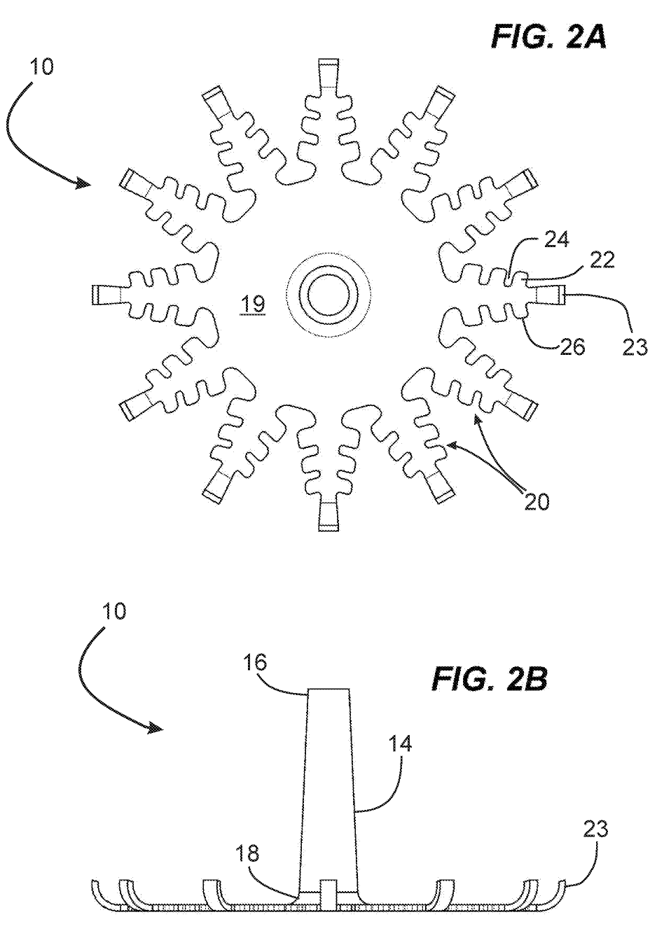

FIGS. 1-2 are various perspective views of a Christmas tree lights hanger 10 according to an embodiment of the present invention. Now referring to FIGS. 1-2, a Christmas tree lights hanger 10 is illustrated. The Christmas tree lights hanger comprises a frustum cone member 14 having a top portion 16 and a bottom portion 18. A hub member 19 extends generally perpendicularly from the bottom portion. In one embodiment, a plurality of spokes 20 having a distal end and a proximal end which extends radially from the hub member. The proximal end of each of the plurality of spokes connects with the hub member. In one embodiment, each of the plurality of spokes has a plurality of teeth 22 that define a plurality of gaps 24, wherein the combination of teeth and gaps provide a plurality of hooks 26. The plurality of hooks are located on the left and right side of each of the plurality of spokes providing support for hanging strings of Christmas lights. This will be described in greater detail below.

In one embodiment, each of the plurality of spokes comprises a curved catch 23 at the distal end. The curved catch prevents a string of Christmas lights from falling off a spoke if the lights happen to disengage from the plurality of spokes.

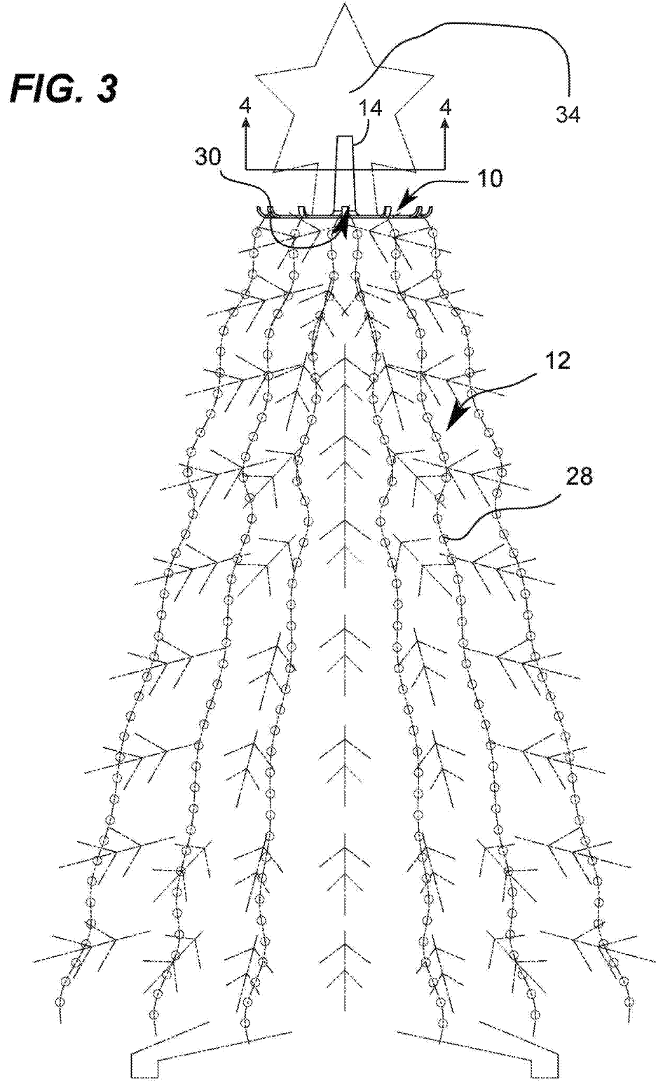

FIG. 3 is a perspective view a Christmas tree lights hanger 10 in use according to an embodiment of the present invention. Referring now to FIG. 3, the Christmas tree lights hanger is placed at the top of a Christmas tree 12 as illustrated. As previously mentioned, it is a particular advantage of the present invention that the Christmas tree lights hanger supports tree lights 28 on the plurality of hooks. Then the tree lights can be positioned on the Christmas tree as well known in the art. In one embodiment, the frustum cone member provides support for placing a tree-topper decoration 34, such as a star as illustrated.

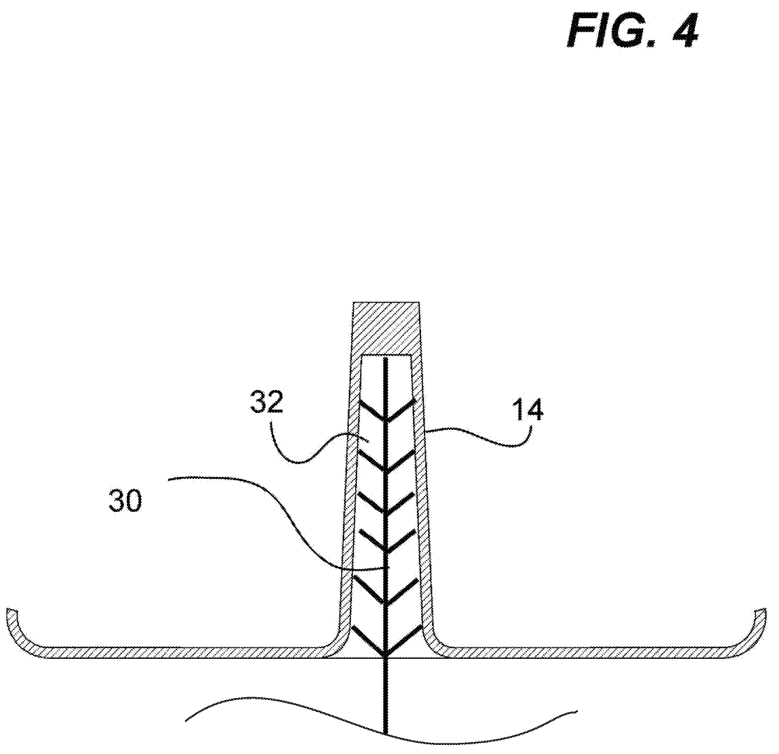

FIG. 4 is a cross-sectional view taken along section line 4-4 of FIG. 3. Referring now to FIG. 4, the Christmas tree lights hanger and specifically the frustum cone member comprises a hollow interior 32. During use, the Christmas tree lights hanger is placed at the top of the Christmas tree, and more particularly the hollow interior is placed on the Christmas tree's leader branch 30 as illustrated. In one embodiment, the Christmas tree lights hanger is preferably made from an integral piece of injection molded polymer based resin.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A tree lights hanger comprising:
a frustum cone member having a top portion, a bottom portion, and a hollow interior, wherein the hollow interior is configured to be placed on a leader branch of a tree;
a hub member extending generally perpendicularly from the bottom portion; and
a plurality of spokes extending radially from the hub member, wherein each of the plurality of spokes has a distal end and a proximal end.

2. The tree lights hanger of claim 1, wherein each of the plurality of spokes has a plurality of teeth that define a plurality of gaps, wherein the combination of teeth and gaps provide a plurality of hooks.

3. The tree lights hanger of claim 2, wherein the plurality of hooks are located on the left and right side of each of the plurality of spokes providing support for hanging strings of lights.

4. The tree lights hanger of claim 3, wherein each of the plurality of spokes comprises a curved catch at the distal end.

5. The tree lights hanger of claim 4, wherein the curved catch is configured to prevent the strings of lights from falling off a spoke of the plurality of the spokes.

6. The tree lights hanger of claim 1, wherein the top portion of the frustum cone member is configured to hold a tree-topper decoration.

7. The tree lights hanger of claim 1, wherein the tree lights hanger is made from an integral piece of injection molded polymer based resin.

8. The tree lights hanger of claim 1, wherein the tree is a Christmas tree.

9. A Christmas tree lights hanger comprising:
a frustum cone member having a top portion, a bottom portion, and a hollow interior, wherein the hollow interior is configured to be placed on a leader branch of a Christmas tree;
a hub member extending perpendicularly from the bottom portion;
a plurality of spokes extending radially from the hub member, wherein each of the plurality of spokes has a distal end and a proximal end, wherein each of the plurality of spokes has a plurality of teeth that define a plurality of gaps, wherein the combination of teeth and gaps provide a plurality of hooks, the plurality of hooks are located on the left and right side of each of the plurality of spokes providing support for hanging strings of Christmas lights; and
a curved catch located at the distal end of each of the plurality of spokes, wherein the curved catch is configured to prevent the strings of lights from falling off a spoke of the plurality of the spokes.

10. The Christmas tree lights hanger of claim 9, wherein the top portion of the frustum cone member is configured to hold a Christmas tree-topper decoration.

11. The Christmas tree lights hanger of claim 9, wherein the Christmas tree lights hanger is made from an integral piece of injection molded polymer based resin.
